(19) United States
(12) Patent Application Publication
(10) Pub. No.: US 2007/0245828 A1
(43) Pub. Date: Oct. 25, 2007

(54) Vibration test method, vibration test apparatus and recording medium storing a vibration test program

(75) Inventors: Takamasa Nakajima, Izumi-shi (JP); Kazuki Tsuda, Izumi-shi (JP); Zenji Sakai, Osaka-shi (JP); Kazuyoshi Ueno, Osaka-shi (JP); Masakazu Shirahoshi, Osaka-shi (JP); Koji Kawata, Osaka-shi (JP); Yoshikado Yamauchi, Osaka-shi (JP)

Correspondence Address: KRATZ, QUINTOS & HANSON, LLP, 1420 K Street, N.W., Suite 400, WASHINGTON, DC, 20005, US

(73) Assignees: OSAKA PREFECTURAL GOVERNMENT, Osaka-shi (JP); IMV CORPORATION, Osaka-shi (JP)

(21) Appl. No.: 11/640,169

(22) Filed: Dec. 18, 2006

(30) Foreign Application Priority Data
Apr. 20, 2006 (JP) 2006-116890

(51) Int. Cl. G01H 11/00

(52) U.S. Cl. 73/649

(57) ABSTRACT

Disclosed is a vibration test method for evaluating the vibration resistance of a specimen, comprising a test specification setting step (S10) of determining reference vibration conditions for the specimen based on transport conditions during actual transportation; a reference value attainment step (S20) of calculating an amplitude level and a reference accumulated fatigue value of the specimen under the reference vibration conditions; a test condition determination step (S30) of determining test vibration conditions and a test time based on an allowable amplification factor of the amplitude level and a desired vibration time, so that an accumulated fatigue value which is calculated from the vibration detection value of the specimen satisfies the reference accumulated fatigue value; and a vibration-imparting step (S40) of vibrating the specimen based on the test vibration conditions and the test time. In accordance with the vibration test method, a vibration test that conforms to the actual transportation environment can be readily performed with high accuracy.

### FIELD OF THE INVENTION

The present invention relates to a vibration test method and apparatus as well as a recording medium storing a vibration test program, and more particularly to a vibration test method and apparatus as well as a recording medium storing a vibration test program for evaluating the vibration resistance of products transported by means such as automobiles, trains, etc., and of devices and components installed in equipment subjected to vibration, such as transportation means.

### BACKGROUND OF THE INVENTION

Conventionally, preliminary vibration tests are conducted on transported products such as cargo, equipment and the like, which are carried by transportation means such as vehicles, trains, airplanes, etc., so as to evaluate their durability. For example, the method disclosed in Patent Publication 1 (Japanese Unexamined Patent Publication No. 2005-181195) is known as such a vibration test.

The vibration test method according to Patent Publication 1 is as follows. Transport conditions, such as vibration acceleration, transport time, vibration frequencies and the like, which arise during actual transportation in a transportation means, such as a vehicle, are stored in a database beforehand. A vibration test machine is then operated at a vibration acceleration that corresponds to the transport condition selected by the user, so as to measure the vibration acceleration of transported products. The machine evaluates, based on the obtained vibration acceleration, a theoretical accumulated fatigue value that will be accumulated in the transported products during actual transportation. Then, the vibration acceleration is gradually increased from that of the transport condition during actual transportation, and a vibration test is run until the sum of accumulated fatigue values given at each vibration acceleration satisfies the theoretical accumulated fatigue value.

This vibration test method is capable of conducting a vibration test in a shorter time than the actual transport time while reflecting the actual transportation environment. The method, however, leaves room for improvement in that if the vibration imparted to the specimens is increased in order to shorten the test time, the possibility of the specimens being damaged during the test increases, thus requiring a certain degree of experience and skill.

### DISCLOSURE OF THE INVENTION

Accordingly, an object of the present invention is to provide a vibration test method, a vibration test apparatus and a recording medium storing a vibration test program, all of which are capable of readily carrying out a vibration test that conforms to an actual transportation environment with high accuracy.

The aforementioned object of the invention is achieved by a vibration test method for evaluating the vibration resistance of a transported product, the method comprising a test specification setting step of determining reference vibration conditions for a specimen based on transport conditions during actual transportation; a reference value attainment step of calculating an amplitude level and a reference accumulated fatigue value of the specimen under the reference vibration conditions; a test condition determination step of determining test vibration conditions and a test time based on an allowable amplification factor of the amplitude level and a desired vibration time, so that an accumulated fatigue value which is calculated from a vibration detection value of the specimen satisfies the reference accumulated fatigue value; and a vibration-imparting step of vibrating the specimen based on the test vibration conditions and the test time. In accordance with this vibration test method, a vibration test can be readily performed under optimal test conditions which allow the test time to be shortened while maintaining high testing accuracy.

In this vibration test method, the test specification setting step may comprise the step of calculating a safety factor using at least a variation coefficient of variation in the durability of each specimen, an allowable damage probability of the specimen that is acceptable during actual transportation, and a desired damage probability in the vibration test of the specimen having an equal damage probability to the allowable damage probability, and then multiplying the accumulated fatigue value resulting from the transport conditions during actual transportation by the safety factor, so as to evaluate the reference accumulated fatigue value. In accordance with this vibration test method, it is possible to maintain high testing accuracy, even though the test time is shorter and the quantity of specimens is smaller than those during actual transportation. This reduces the incidence of customer complaints in the market while preventing overpackaging to lower the cost.

In this vibration test method, the reference value attainment step may comprise the step of determining, when there are a plurality of transport routes in actual transportation, the reference accumulated fatigue value by calculating an accumulated fatigue value for each transport route. In accordance with this vibration test method, a vibration test which accurately reflects the transport conditions during actual transportation can be performed with improved testing accuracy.

In this vibration test method, the vibration-imparting step may comprise the step of determining the presence of damage to the specimen based on a change in an index that is based upon the vibration detection value of the specimen. In accordance with this vibration test method, it is possible to detect a defect or flaw in the specimen which is difficult to visually confirm, thereby enhancing the reliability of the vibration test.

The aforementioned object of the invention is also achieved by a vibration test apparatus comprising a vibration generator for imparting vibration to a specimen; a controller for controlling the operation of the vibration generator; and a vibration detector for detecting the vibration of the specimen, wherein the controller comprises an input unit capable of inputting an instruction from a user; a test specification setting unit that determines reference vibration conditions for the specimen based on the transport conditions during actual transportation input from the input unit; a reference value attainment unit that calculates an amplitude level and a reference accumulated fatigue value of the specimen under the reference vibration conditions; and a test condition determination unit that determines test vibration conditions and a test time based on an allowable amplification factor of the amplitude level and a desired vibration time, so that an accumulated fatigue value which is calculated from the vibration detection value of the specimen satisfies the reference accumulated fatigue value, the vibration test apparatus making the vibration generator operate based on the test vibration conditions and the test time.

The aforementioned object of the invention is further achieved by a vibration test program for use in a vibration test apparatus, the apparatus comprising a vibration generator for imparting vibration to a specimen; a controller for controlling the operation of the vibration generator; and a vibration detector for detecting the vibration of the specimen, the vibration test program allowing the controller to function as an input unit capable of inputting an instruction from a user; a test specification setting unit that determines reference vibration conditions for the specimen based on the transport conditions during actual transportation input from the input unit; a reference value attainment unit that calculates an amplitude level and a reference accumulated fatigue value of the specimen under the reference vibration conditions; and a test condition determination unit that determines test vibration conditions and a test time based on an allowable amplification factor of the amplitude level and a desired vibration time, so that an accumulated fatigue value which is calculated from the vibration detection value of the specimen satisfies the reference accumulated fatigue value, the vibration test program making the vibration generator operate based on the test vibration conditions and test time.

As with the above-described vibration test method, the vibration test apparatus and the vibration test program are capable of readily carrying out a vibration test under optimal conditions which allow the test time to be shortened while maintaining high testing accuracy.

The vibration test program may be recorded in a mobile recording medium, such as a floppy disk (FD), CD-ROM or the like, or a recording medium such as a hard disk in the vibration test apparatus. The vibration test program may also be recorded onto a recording medium via a network, such as the Internet.

### BRIEF DESCRIPTION OF THE DRAWINGS

FIG. 1 is a block diagram showing the schematic configuration of a vibration test apparatus in accordance with an embodiment of the present invention;

FIG. 2 is a flowchart for use in illustrating the outline of a vibration test method in accordance with the embodiment;

FIG. 3 is a flowchart for use in illustrating a test specification setting step;

FIG. 4 is a diagram showing an example of a test specification setting screen;

FIG. 5 is a diagram showing an example of a scenario setting screen;

FIG. 6 is a diagram showing an example of an edit screen;

FIG. 7 is a diagram schematically showing an example of a transport scenario;

FIG. 8 is a flowchart for use in illustrating a reference value attainment step;

FIG. 9 is a diagram showing an example of a preliminary test setting screen;

FIG. 10 is a flowchart for use in illustrating a test condition determination step;

FIG. 11 is a diagram showing an example of an actual test setting screen;

FIG. 12 is a flowchart for use in illustrating a vibration-imparting step; and

FIG. 13 is a graph showing an example of change over time of the accumulated fatigue rate in an actual vibration test.

### BEST MODE FOR CARRYING OUT THE INVENTION

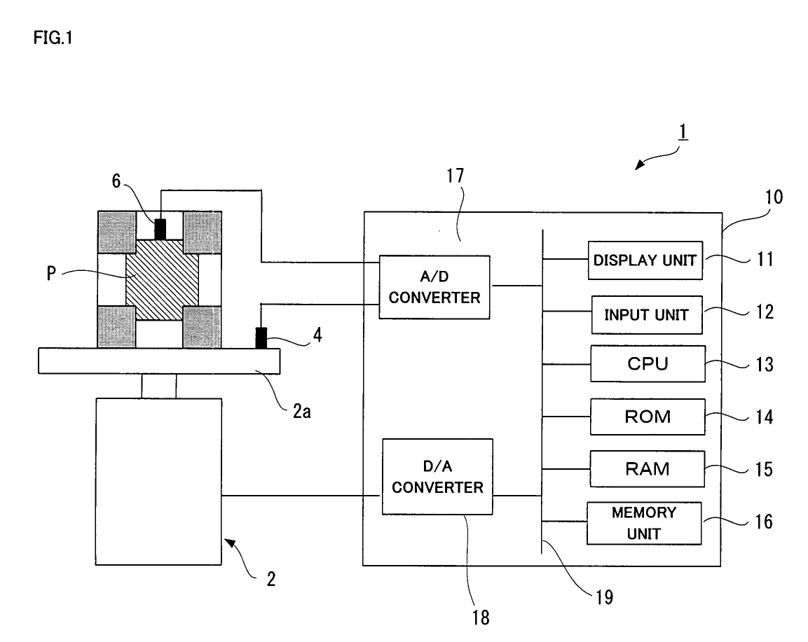

Embodiments of the present invention are now described with reference to the accompanying drawings. FIG. 1 is a block diagram showing the schematic configuration of a vibration test apparatus in accordance with an embodiment of the present invention.

As shown in FIG. 1, the vibration test apparatus 1 comprises a vibration generator 2 having a vibrating table 2a on which a specimen P is mounted, a controller 10 for controlling the operation of the vibration generator 2, a first acceleration sensor 4 that detects vibration of the vibrating table 2a, and a second acceleration sensor 6 that detects vibration of the specimen P. The first acceleration sensor 4 and the second acceleration sensor 6 are attached to the vibrating table 2a and the specimen P, respectively, to output each detected vibration acceleration to the controller 10. A plurality of second acceleration sensors 6 may be provided so that they can be attached to a plurality of areas of the specimen P or attached to each of multiple stacked specimens P.

The controller 10 comprises a display unit 11, an input unit 12, a CPU 13, a ROM 14, a RAM 15 and a memory unit 16, all of which are connected via a bus 19. This controller 10 is connected to the first acceleration sensor 4 and the second acceleration sensor 6 via an A/D converter 17, and is also connected to the vibration generator 2 via a D/A converter 18. The controller may be composed of an information processing apparatus, e.g., a personal computer.

The display unit 11 is composed of a liquid crystal display monitor, CRT monitor or the like, and the input unit 12 is composed of a mouse, input keys, a touch panel or the like. The CPU 13 controls the operation of the vibration generator 2 by execution of a vibration test program, and performs a vibration test on the specimen P as described below. The ROM 14 stores transport conditions (e.g., vibration acceleration, transport time, vibration frequencies, etc., during actual transportation) corresponding to various transport routes, a vibration test program executed by the CPU 13, and the like. The RAM 15 stores temporary data which is created during execution of the vibration test program.

The memory unit 16 stores a variety of information. Such information includes vibration data previously measured for the specimen P in each of the various transport routes, transfer functions for reproducing transported states, information input from the input unit 12, detection information from the first acceleration sensor 4 and second acceleration sensor 6, and calculation information from the CPU 13.

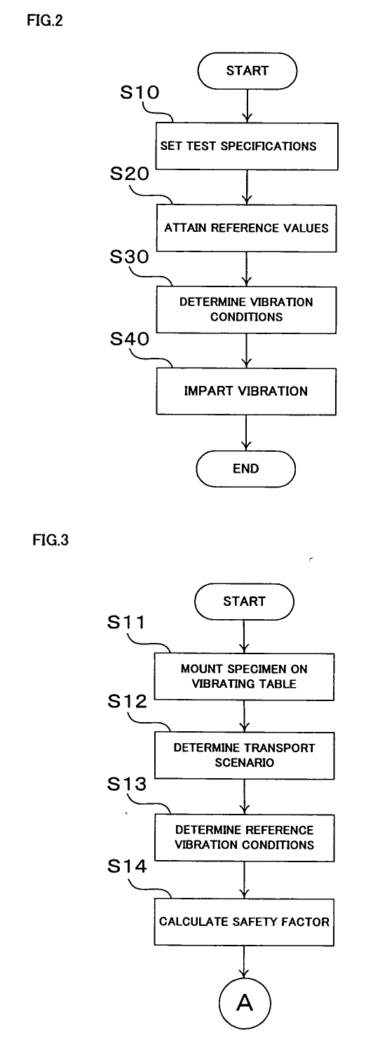

A description is next given of a method for performing a vibration test on the specimen P using the vibration test apparatus 1 described above. The flowchart of FIG. 2 illustrates the general procedure of the vibration test method in accordance with this embodiment. A test specification setting step is first performed in which reference vibration conditions for the specimen P are determined based on transport conditions during actual transportation, so as to determine vibration conditions that reflect the transported state during actual transportation (Step S10). Next, a reference value attainment step is performed in which an amplitude peak value and a reference accumulated fatigue value of the specimen P under the reference vibration conditions are determined, so as to determine such reference values used in determining the test conditions during an actual vibration test (Step S20). A test condition determination step is subsequently performed in which test vibration conditions and a test time are determined based on an allowable amplification factor of the amplitude peak value and a reference vibration time, so that an accumulated fatigue value which is calculated from the vibration detection value of the specimen P satisfies the reference accumulated fatigue value, thereby determining the test conditions during the actual vibration test (Step S30). After this, an actual vibration test is performed by executing a vibration-imparting step in which the specimen P is vibrated based on the test vibration conditions and the test time (Step S40). Each step is described in further detail below.

(1) Test Specification Setting Step (Step S10)

The test specification setting step is explained referring to the flowchart shown in FIG. 3, as necessary.

A specimen P is first mounted on the vibrating table 2a (Step S11). Examples of specimens P include transported products, such as precision machines and the like housed within containers, such as corrugated boards and the like, together with cushioning materials such as cellular materials, paper, wood, etc. In view of the transported state during actual transportation, the specimen P is preferably mounted so as to enable a vibration test that takes into consideration non-linearity in vibration transfer. For example, when stacked products (in a vertically stacked state) are transported during actual transportation, a plurality of specimens P may be stacked on the vibrating table 2a in the vibration test. In addition to the event of transporting stacked products, non-linearity in vibration transfer may occur, for example, when the transported products vibrate from rattling or hitting, or when the transported products are fluid such as liquids.

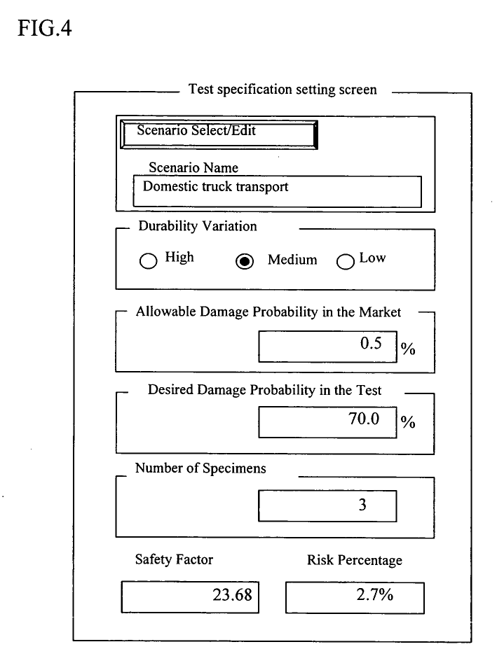

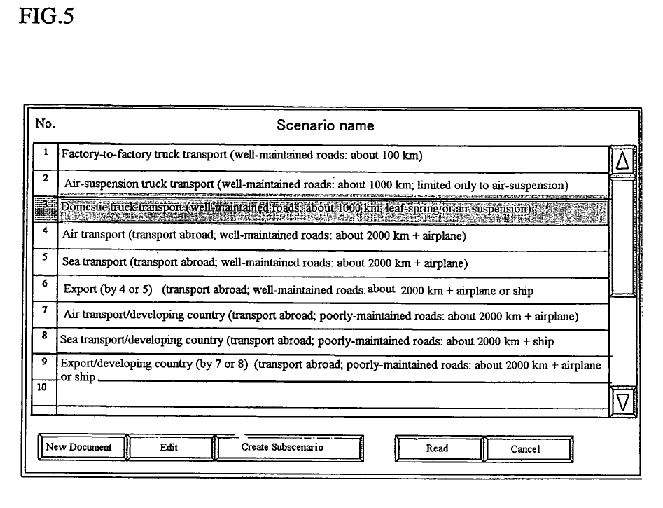

A user is then prompted to enter an actual transport route via the input unit 12 of the controller 10, so as to determine a transport scenario representing the transport conditions for the entire transport route (Step S12). The CPU 13 causes the display unit 11 to display a screen for setting the test specifications, for example, as shown in FIG. 4. The screen shown in FIG. 5 is displayed on the display unit 11 by the user pressing the “Scenario Select/Edit” button on the input unit 12.

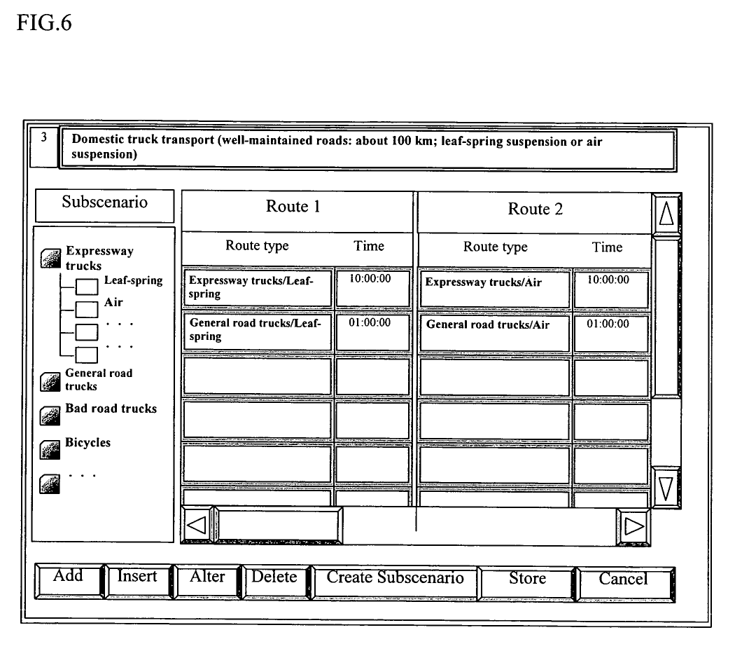

The scenario setting screen shown in FIG. 5 displays a list of scenario names, each containing predetermined transport conditions (i.e., transport distance, time, road, whether or not options are available, etc.) for various transportation means, such as a truck, airplane, ship and the like, so that the user can select a scenario name in view of the actual transportation. For example, if the user selects “3. Domestic Truck Transport” field by mouse and then presses the “Read” button, the CPU 13 retrieves the transport conditions for the selected scenario name as a subscenario, and stores the conditions in the memory unit 16.

Where modification(s) have to be made to the transport conditions for the selected scenario name, the user may press the “Edit” button on the scenario setting screen shown in FIG. 5, thereby causing the CPU 13 to display an edit screen as shown in FIG. 6 on the display unit 11. In this edit screen, the user can select item(s) to be modified and make modification(s) to them. If there is no scenario name corresponding to the actual transportation, the user may press the “New Document” button on the scenario setting screen shown in FIG. 5 to display the same edit screen as that of FIG. 6, and input the transport conditions corresponding to the new scenario name (e.g., bicycle, cart, etc.).

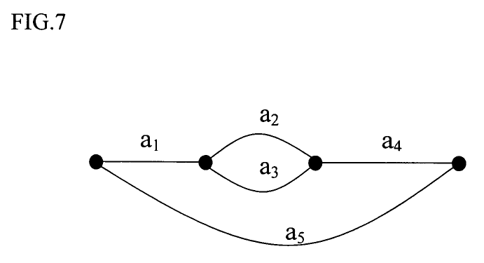

In actual transportation, it is common to use more than one transportation means, and there are few cases of transporting via a single transportation means. Therefore, after reading the selected scenario, the CPU 13 displays the scenario setting screen shown in FIG. 5 again so that the user can select another scenario name. When the user has selected a plurality of scenario names, the CPU 13 prompts the user to enter information on their correlation, lastly creating a macro expression of the entire transport scenario consisting of various subscenarios. For example, when a transport scenario consists of subscenarios a₁ to a₅ as shown in FIG. 7, the scenario is expressed by {a₁ and (a₂ or a₃) and a₄} or a₅.

The CPU 13 subsequently searches the memory unit 16 based on the determined transportation scenario to acquire vibration data corresponding to each subscenario of the transportation scenario, and creates vibration data for the entire transport scenario by combining these subscenarios, thereby determining reference vibration conditions based on the transport conditions during actual transportation (Step S13).

Vibration data stored in the memory unit 16 can be derived by, for example, using a vibrograph to actually measure vibration acceleration of the surface on which transported products are mounted (e.g., the cargo bed of a truck) during actual transportation under the transport conditions of each scenario name, for example, as displayed in the scenario setting screen of FIG. 5. In this embodiment, vibration data is stored in the memory unit 16 in the form of power spectral densities (hereinafter abbreviated to PSDs) calculated by Fourier-transforming actual waveform data of a given period of time (time series data). However, the actual waveform data (time series data) itself may be stored as vibration data in order to enhance the testing accuracy. Vibration data can also be derived by applying data processing to the actual waveform data (time series data). Examples of such data processing methods include histogram analysis techniques known as fatigue evaluation methods, such as peak/valley, maximum/minimum, amplitude, level crossing, rain-flow, two-dimensional rain-flow, and other methods.

The CPU 13 then prompts the user to enter a variation coefficient, an allowable damage probability, and a desired damage probability on the test specification setting screen shown in FIG. 4, so as to calculate a safety factor based on the information entered by the user via the input unit 12 (Step S14).

The variation coefficient is an index of variation in the durability of each transported product, which is, for example, set to any one of 120%, 60% or 30% by the user selecting from the three levels, i.e., high, medium or low. The input of a variation coefficient may be done by storing a previously measured variation coefficient for each kind of transported product (e.g., displays, DVDs, bags-in-boxes, etc.) in the memory unit 16, so that the corresponding variation coefficient is read and set by the user selecting the kind of products.

The allowable damage probability is an index of the damage probability that is acceptable during actual transportation. The allowable damage probability is set to a small value when the transported products are expensive or can cause danger when broken, and is set to a large value when they are inexpensive or readily replaceable.

The desired damage probability is an index of the probability of the specimen P being broken by a vibration test when the damage probability of the specimen P is substantially equal to the allowable damage probability. The desired damage probability can be set to a small value when there is a large quantity of specimens P, and is set to a large value when there is a small quantity of specimens P.

In the vibration test method of this embodiment, an accumulated fatigue value X_{R} resulting from the transport conditions during the actual transportation is multiplied by a safety factor S, so as to evaluate a reference accumulated fatigue value X_{T}(namely, X_{T}=S×X_{R}) which is imparted to the specimen, in order to maintain a high testing accuracy even though the test time is shorter and the quantity of specimens is smaller than those during the actual transportation. This allows the vibration test to be performed under optimal conditions, so as to reduce the incidence of customer complaints in the market while preventing overpackaging to reduce costs.

Assuming that the probability distribution of durabilities of the transported products is a Weibull distribution, the input variation coefficient η, allowable damage probability P_{M} and desired damage probability P_{T} are represented by the mathematical expressions (1), (2) and (3), respectively, shown below:

η=[{Γ(1+(2/α))/{Γ(1+(1/α))}²}−1]^{1/2} (1)

P_{M}=1−exp{−(x_{R}/β)^{α}} (2)

P_{T}=1−exp{−(x_{T}/β)^{α}} (3)

wherein each α and β are the shape parameter and scale parameter, respectively, of the Weibull distribution.

Using these expressions, the CPU 13 calculates a safety factor S based on the input variation coefficient η, allowable damage probability P_{M} and desired damage probability P_{T}, and displays the safety factor on the test specification setting screen of FIG. 4. This safety factor determination method can be applied, not only to determining the reference accumulated fatigue value added to vibration tests as in this embodiment, but also to deriving the vibration test conditions using a tailoring technique, as well as the test conditions of (drop) shock tests, bump tests and the like. As a result, not only the level of expected load on products in the market but the safety guarantee standard (allowable damage probability in the market) of the products, variation in the products, the number of products and so forth can be reflected likewise in the test conditions of these tests.

The number N of specimens P can also be input in the test specification setting screen of FIG. 4. The CPU 13 calculates a risk percentage of the test D based on the input desired damage probability P_{T} and the number N of the specimens, and displays the risk percentage of the test D. The term “risk percentage” of the test denotes the probability of all the tested specimens P being accepted without breakage, even though the transported products fail to satisfy the allowable damage probability P_{M}. The risk percentage of the test is represented by the mathematical expression (4) shown below:

D=(1−P_{T})^{N} (4)

In this embodiment, the risk percentage of the test D is determined based on the input desired damage probability P_{T} and number N of specimens. As is clear from the expression (4), however, when a preferable value has been preset for the risk percentage of the test D, the desired damage probability P_{T} can be determined by inputting the number N. In other words, the safety factor S can also be calculated by assuming an input of the number N to be an input of the desired damage probability P_{T}.

The safety factor calculation described above may also be performed in the reference value attainment step (Step S20) described below, instead of the test specification setting step (Step S10) as in this embodiment.

(2) Reference Value Attainment Step (Step S20)

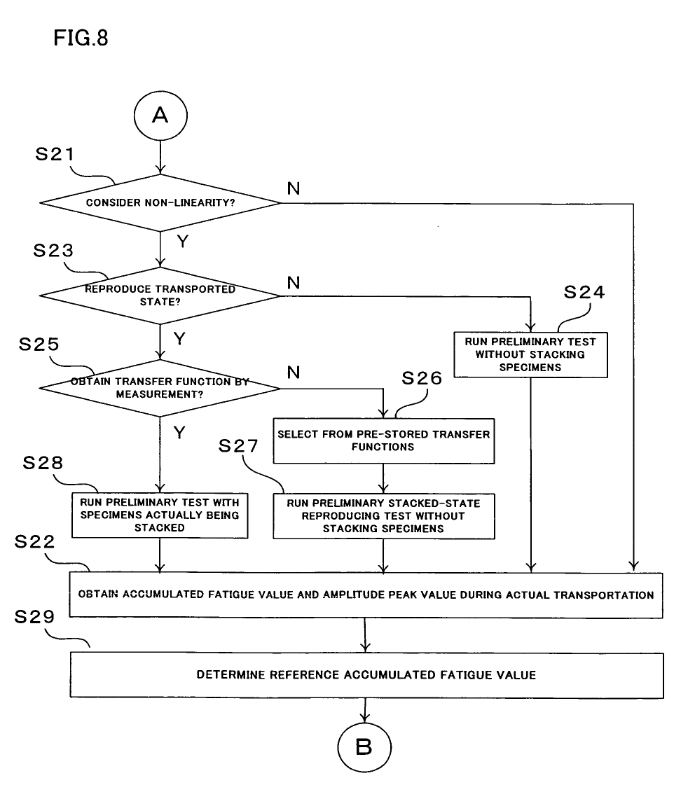

The reference value attainment step is explained referring to the flowchart shown in FIG. 8, as necessary.

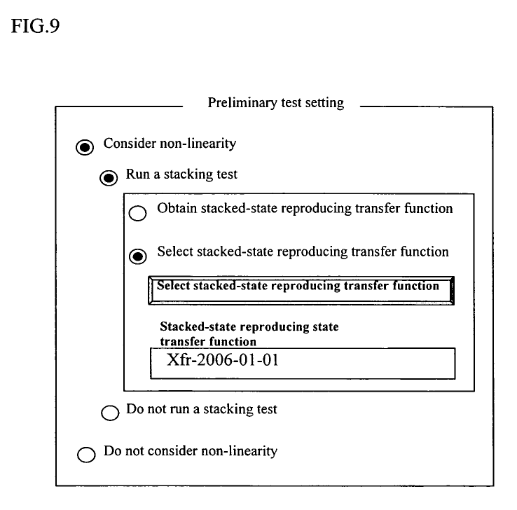

The user selects whether non-linearity is taken into consideration in the actual test or not (Step S21). The selection can be done on a preliminary test setting screen as shown in FIG. 9, which is displayed on the display unit 11 by the CPU 13. If the user clicks the “Do not consider non-linearity” column on the preliminary test setting screen, the CPU 13 determines that the vibration data of specimens P during actual transportation is the same as the reference vibration conditions created at the test specification setting step (Step S10), and calculates an accumulated fatigue value and an amplitude peak value of the transported products during actual transportation (Step S22).

In this embodiment, the amplitude peak value is used as an index representing the amplitude level of the transported products, but other indices of amplitude level may also be used, such as root mean square (RMS) and the like.

Conversely, if the user takes non-linearity into consideration, he or she selects whether the transported state will be reproduced or not (Step S23). On the preliminary test setting screen shown in FIG. 9, information related to a stacked state can be input as an example of transported states where non-linearity in vibration transfer may occur. If the transported products are not stacked during actual transportation, or the user has judged that the influence of stacking is negligible, then a specimen P is mounted on the vibrating table 2a without being stacked, and the user clicks the “Do not run a stacking test” column. This causes the CPU 13 to control the operation of the vibration generator 2 based on the vibration data corresponding to the transport scenario created at Step S21, and run a preliminary test with the specimen P not being stacked (Step S24). The CPU 13 subsequently calculates an accumulated fatigue value and an amplitude peak value of the transported products during actual transportation based on a detection made by the second acceleration sensor 6 attached to the specimen P during the preliminary test (Step S22).

If the transported state is reproduced at Step S23, the user subsequently chooses whether a transfer function representing non-linearity is selected from the preset transfer functions or is derived by actual measurement (Step S25). When selecting a transfer function for reproducing the stacked state from the variety of preset transfer functions, the user clicks the “Select stacked-state reproducing transfer function” column on the preliminary test setting screen of FIG. 9, and enters the name of a stacked-state reproducing transfer function stored in the memory unit 16, thereby selecting the transfer function for reproducing the stacked state (Step S26). In this case, a preliminary test for reproducing the stacked state can be run (Step S27) without the specimen P being stacked on the vibrating table 2a, by the CPU 13 controlling the operation of the vibration generator 2 based on the reference vibration conditions created at the test specification setting step (Step S10) and the selected transfer function. An accumulated fatigue value and an amplitude peak value of the transported products during actual transportation are subsequently determined (Step S22) based on a detection made by the second acceleration sensor 6 attached to the specimen P during the preliminary test.

If the user chooses to perform actual measurement at Step S25, specimens P are stacked on the vibrating table 2a, and the user clicks the “Obtain stacked-state reproducing transfer function” column on the preliminary test setting screen of FIG. 9, whereupon a preliminary test in which the specimens P are actually stacked is run by the CPU 13 controlling the operation of the vibration generator 2 based on the reference vibration conditions created in the test specification setting step at Step S10 (Step S28). An accumulated fatigue value and an amplitude peak value of the transported products during actual transportation are subsequently determined based on detections made by the second acceleration sensor 6 attached to each of the specimens P during the preliminary test (Step S22). At this time, the CPU 13 is capable of deriving a transfer function for reproducing the stacked state based on the detection data from each second acceleration sensor 6, and storing the transfer function in the memory unit 26.

One example of the accumulated fatigue value calculation method at Step S22 comprises determining PSDs based on time series data of a given period which is detected by the second acceleration sensor 6 attached to each specimen P, and calculating an accumulated fatigue value based on the PSDs. The accumulated fatigue value calculation based on PSDs may be performed, for example, in accordance with the method disclosed in Japanese Unexamined Publication No. 2005-181195.

In the accumulated fatigue value calculation method, the accumulated fatigue value corresponding to the entire transport scenario is calculated using an accumulated fatigue value calculated for each subscenario. For example, in the case of the transport scenario shown in FIG. 7, when it is assumed that the accumulated fatigue values corresponding to the subscenarios a₁ to a₅ are A₁ to A₅, respectively, the accumulated fatigue value of the transported products during actual transportation is max[sum{A₁, max(A₂, A₃), A₄}, A₅], where max is the maximum value, and sum is the total sum.

When determining the accumulated fatigue value during actual transportation, variation in the accumulated fatigue value expected in the market may further be considered with respect to the accumulated fatigue value X_{R} determined as above. For example, let X_{R} be an accumulated fatigue value having a reliability of 3δ (99.87%), then X_{R}=(1+3η_{XR})μ_{XR}, wherein η is the variation coefficient, and μ_{XR} is the mean accumulated fatigue value.

After determining the accumulated fatigue value of the transported products during actual transportation at Step S22, this accumulated fatigue value is multiplied by the safety factor calculated at Step S14, thereby determining the reference accumulated fatigue value (Step S29).

In obtaining the amplitude peak value at Step S22, the maximum amplitude peak value of the transported products of all the subscenarios may be used as the amplitude peak value for the entire transport scenario.

(3) Test Condition Determination Step (Step S30)

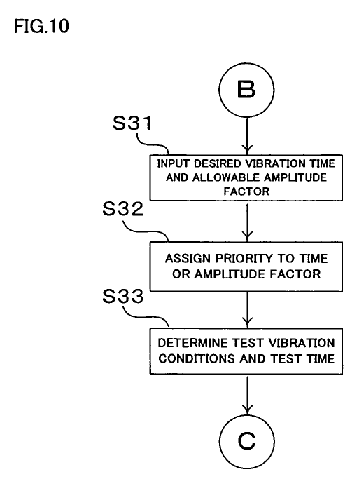

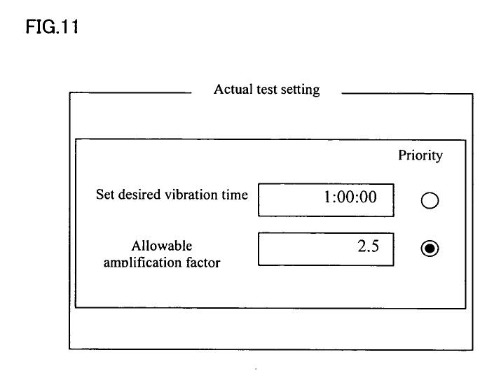

The test condition determination step is explained referring to the flowchart shown in FIG. 10, as necessary.

The user inputs a desired vibration time and an allowable amplification factor in the test (Step S31). The inputs can be made on an actual test setting screen as shown in FIG. 11, which is displayed by the CPU 13 on the display unit 11. If the desired vibration time and allowable amplification factor are incompatible, the user can choose which of the two should take priority (Step S32).

The desired vibration time is the time during which the user wishes to vibrate the specimen P in the test. The allowable amplification factor is the maximum amplification factor that is permitted for the amplitude peak value of the transported products during actual vibration. In general, reducing the desired vibration time allows the test to be terminated in a short time, resulting in improved test efficiency. However, it inevitably increases the amplification factor of the amplitude peak value of the transported products, resulting in a higher possibility of exceeding the allowable amplification factor. The increase in the amplification factor causes a greater difference between the level of vibration during actual vibration and that during the test, which may result in reduced testing accuracy.

The CPU 13 determines test vibration conditions and a test time for an actual test based on the input desired vibration time, allowable amplification factor, and priority order (Step S33). More specifically, an accumulated fatigue rate V(X_{T}) of the specimen P is calculated in accordance with the mathematical expression (5) shown below, based on PSD values (PSD₀) which have been determined based on the acceleration detection data from the second acceleration sensor 6 for detecting the vibration of the specimen P.

$$V ( {x}_{T} ( {f}_{i} ) ) = {\{ {\int }_{fi - Δ f}^{fi + Δ f} {PSD}_{0} ( f ) \cdot d f \}}^{m / 2} \qquad ( 5 )$$

The reference accumulation fatigue X_{T}(fᵢ) for each frequency band is subsequently divided by the desired vibration time T, and the result is defined as the reference accumulated fatigue rate (X_{T}(fᵢ)/T). The CPU 13 controls the operation of the vibration generator 2 so that the aforementioned accumulated fatigue rate satisfies the reference accumulated fatigue rate, and the amplitude peak value detected by the second acceleration sensor 6 does not exceed the allowable amplification factor. This allows the test to be terminated in the desired vibration time T. Note that a safety function is preferably provided for controlling the operation of the vibration generator 2 so that the rating of the vibration generator 2 is not exceeded.

If non-linearity in vibration transfer is not taken into consideration, the detection data obtained from the first acceleration sensor 4 attached to the vibrating table 2a may be used as detection data for use in calculating the accumulated fatigue rate of the specimen P. When a plurality of second acceleration sensors 6 are attached to each of multiple stacked specimens P, the operation of the vibration generator 2 is preferably controlled so that the slowest accumulated fatigue rate satisfies the reference accumulated fatigue rate. This allows the test to be terminated in the desired vibration time T.

That is, when the input desired vibration time and allowable amplification factor are compatible, the desired vibration time is set as a test time without modification, and the aforementioned pattern of the CPU 13 controlling the operation of the vibration generator 2 is set as test vibration conditions.

In contrast, when the amplitude peak value detected by the second acceleration sensor 6 has exceeded the allowable amplification factor during the CPU 13 controlled operation of the vibration generator 2, the CPU 13 recognizes the priority order input on the actual test setting screen, and continues, if priority is placed on the desired vibration time, controlling the operation of the vibration generator 2, and displays the actual amplitude amplification factor on the display unit 11. Conversely, if priority is placed on the allowable amplification factor, the CPU 13 controls the operation of the vibration generator 2 so that the detected amplitude peak value does not exceed the allowable amplification factor, and displays on the display unit 11 a test time which is calculated based on the accumulated fatigue rate obtained in this case.

As described above, when the input desired vibration time and allowable amplification factor are incompatible, the CPU 13 operates to satisfy one of the two conditions based on the priority order, and displays a modified value of the other on the display unit 11. The user checks the modified value, and if the value is acceptable, he or she verifies the value by using the input unit 12, allowing the test vibration conditions and test time in the test to be lastly determined. Consequently, it is possible to maintain a high testing accuracy while attaining optimal test conditions which allow the test time to be shortened.

If the detected amplitude peak value has exceeded the allowable amplification factor with a priority being placed on the allowable amplification factor, the CPU 13 reduces the reference accumulated fatigue rate in controlling the operation of the vibration generator 2. However, the test time increases if the reference accumulated fatigue rate is kept low, and therefore once the level of the detected amplitude peak value has become smaller, it is preferable to increase the reference accumulated fatigue rate again.

(4) Vibration-Imparting Step (Step S40)

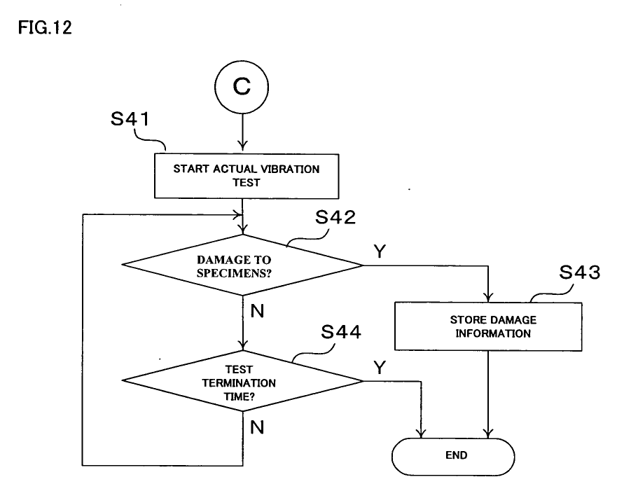

The vibration-imparting step is explained referring to the flowchart shown in FIG. 12, as necessary.

After the specimen P has been mounted on the vibrating table 2a, an actual vibration test is started based on the determined test vibration conditions and test time (Step S41). When specimens P are transported, for example, in a stacked state, the actual test can similarly be performed with the specimens P being stacked.

The second acceleration sensor 6 (which may also be substituted by the first acceleration sensor 4 where possible) detects the vibration acceleration of the specimen P during the actual vibration test. On the basis of this detection, the CPU 13 calculates accumulated fatigue rates of the specimen P in real time in accordance with the aforementioned mathematical expression (5). The CPU 13 subsequently determines the presence of damage to the specimen based on the amount of change in the accumulated fatigue rate (Step S42). For example, when a change in the accumulated fatigue rate has exceeded a threshold value, the CPU 13 determines that the specimen P has been damaged, and provides a warning indication on the display unit 11 while calculating an elapsed time and accumulated fatigue values until that moment, accumulated fatigue rates and PSDs before and after that moment, etc., and stores them in the memory unit 16 as damage information (Step S43). The CPU 13 then terminates the vibration test after the elapse of a given period of time.

In contrast, when determining that the specimen has not been damaged at Step S42, the CPU 13 moves onto Step S44, where it terminates the vibration test when the test termination time has come, or repeats Step S42 and thereafter when the test termination time has yet to come.

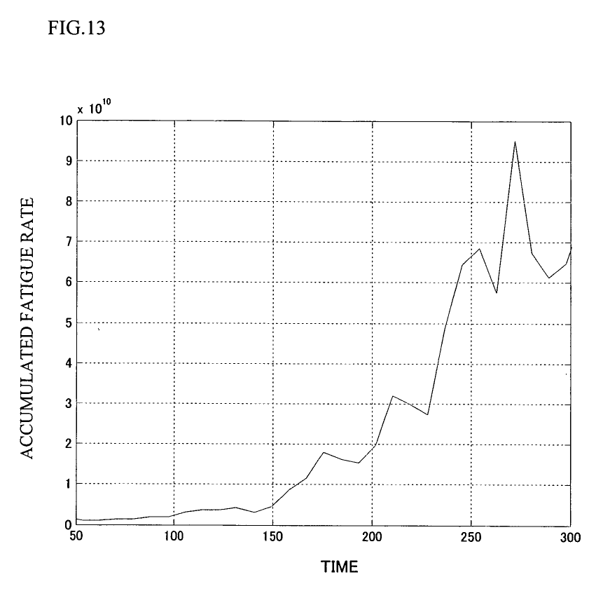

FIG. 13 is a graph showing an example of change over time of the accumulated fatigue rate in an actual vibration test. The accumulated fatigue rate is sharply increased at around 230 seconds from the beginning of the test, and therefore, it is assumed that some kind of breakage has occurred at this point. As described above, in accordance with the method of determining the presence of damage to the specimen P based on the amount of change in the accumulated fatigue rate, it is possible to detect a minute defect or damage in the interior of the specimen that is impossible to visually confirm. Moreover, analysis of the data accumulated in the memory unit 16 is useful for evaluating and improving the vibration resistance.

In this embodiment, the presence of damage to the specimen P is determined based on the amount of change in the accumulated fatigue rate; however, any other indices may be used if they are concerned with the vibration transfer apparatus based upon the vibration detection values of specimens. For example, the presence of damage to the specimen P may be determined based on the amount of change in the PSD, RMS or the like. The presence of specimen damage may also be determined based on the rate of change of such an index, instead of the amount of change.

Although the embodiment describes the specimens as being transported products, the present invention can also be applied to devices and components installed in equipment subjected to vibration, such as transportation means.

1. A vibration test method for evaluating the vibration resistance of a specimen, comprising:
a test specification setting step of determining reference vibration conditions for the specimen based on transport conditions during actual transportation;
a reference value attainment step of calculating an amplitude level and a reference accumulated fatigue value of the specimen under the reference vibration conditions;
a test condition determination step of determining test vibration conditions and a test time based on an allowable amplification factor of the amplitude level and a desired vibration time, so that an accumulated fatigue value which is calculated from a vibration detection value of the specimen satisfies the reference accumulated fatigue value; and
a vibration-imparting step of vibrating the specimen based on the test vibration conditions and the test time.

2. The vibration test method according to claim 1, wherein the test specification setting step comprises the step of calculating a safety factor using at least a variation coefficient of variation in the durability of each specimen, an allowable damage probability of the specimen that is acceptable during actual transportation, and a desired damage probability in the vibration test of the specimen having an equal damage probability to the allowable damage probability, and then multiplying the accumulated fatigue value resulting from the transport conditions during actual transportation by the safety factor, so as to evaluate the reference accumulated fatigue value.

3. The vibration test method according to claim 1, wherein the reference value attainment step comprises the step of determining, when there are a plurality of transport routes in actual transportation, the reference accumulated fatigue value by calculating an accumulated fatigue value for each transport route.

4. The vibration test method according to claim 1, wherein the vibration-imparting step comprises the step of determining the presence of damage to the specimen based on a change in an index that is based upon the vibration detection value of the specimen.

5. A vibration test apparatus comprising a vibration generator for imparting vibration to a specimen; a controller for controlling the operation of the vibration generator; and a vibration detector for detecting the vibration of the specimen, wherein
the controller comprises:
an input unit capable of inputting an instruction from a user;
a test specification setting unit that determines reference vibration conditions for the specimen based on transport conditions during actual transportation input from the input unit;
a reference value attainment unit that calculates an amplitude level and a reference accumulated fatigue value of the specimen under the reference vibration conditions; and
a test condition determination unit that determines test vibration conditions and a test time based on an allowable amplification factor of the amplitude level and a desired vibration time, so that an accumulated fatigue value which is calculated from the vibration detection value of the specimen satisfies the reference accumulated fatigue value;
the vibration test apparatus making the vibration generator operate based on the test vibration conditions and the test time.

6. A recording medium that stores a vibration test program for use in a vibration test apparatus,
the apparatus comprising:
a vibration generator for imparting vibration to a specimen;
a controller for controlling the operation of the vibration generator; and
a vibration detector for detecting the vibration of the specimen,
the vibration test program allowing the controller to function as an input unit capable of inputting an instruction from a user; a test specification setting unit that determines reference vibration conditions for the specimen based on transport conditions during actual transportation input from the input unit; a reference value attainment unit that calculates an amplitude level and a reference accumulated fatigue value of the specimen under the reference vibration conditions; and a test condition determination unit that determines test vibration conditions and a test time based on an allowable amplification factor of the amplitude level and a desired vibration time, so that an accumulated fatigue value which is calculated from the vibration detection value of the specimen satisfies the reference accumulated fatigue value;
the vibration test program making the vibration generator operate based on the test vibration conditions and test time.
